(19) United States
(12) Patent Application Publication
(10) Pub. No.: US 2007/0051449 A1
(43) Pub. Date: Mar. 8, 2007

(54) PNEUMATIC TIRE

(76) Inventor: Kazuma NISHITANI, Osaka-shi, Osaka (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/470,198

(22) Filed: Sep. 5, 2006

(30) Foreign Application Priority Data
Sep. 6, 2005 (JP) 2005-257522

(51) Int. Cl. B60C 13/00

(52) U.S. Cl. 152/524; 152/525

(57) ABSTRACT

The tire cross section height is less than 110 mm. A sidewall rubber disposed in a sidewall portion is formed of a laminated body of a narrow rubber ribbon wound along a circumferential direction of the tire. An outer peripheral surface in a region extending from a shoulder portion of the sidewall rubber to a tire maximum width position is formed of a wide rubber ribbon which is wider than a narrow rubber ribbon and has a thickness of 1.2 to 3.0 mm.

### BACKGROUND OF THE INVENTION

1. Field of the Invention

The present invention relates to a pneumatic tire in which a crack is prevented from being generated in its sidewall outer peripheral wall.

2. Description of the Related Art

As a general producing method of the pneumatic tire, the following method is exemplified. An inner liner rubber and a carcass ply are sequentially stuck and laminated on an outer periphery of a forming drum. Then, annular beads are fitted over both sides of the carcass ply in the widthwise direction, an end of the carcass ply in the widthwise direction is wound back outward and then, a sidewall rubber and other rubber members are sequentially disposed to form a first case. Next, a cylindrical second case comprising a belt member and a tread rubber is disposed on an outer peripheral side of a central portion of the first case, the central portion of the first case is allowed to be swelled and deformed, and is crimped on an inner peripheral surface of the second case. This producing method is disclosed in a Japanese Patent Application Laid-open No. H6-254990.

Conventionally, there is a known ribbon winding technique as a method for forming each rubber member. According to the ribbon winding technique, a rubber ribbon made of band-like unvulcanized rubber composite having small width and small thickness is wound along a circumferential direction many times to form a desired cross section shape. As compared with a technique in which an integrally extruded rubber extrudate is connected annularly, a rubber member such as a sidewall rubber can precisely be formed. When a sidewall rubber is formed by this technique, however, there is a problem that many ribbon interfaces are formed in a sidewall outer peripheral wall 30, and a crack is easily generated due to a step formed along the ribbon interface.

To solve this problem, a Japanese Patent Application Laid-open No. 2004-50985 proposes that an outer peripheral wall in a predetermined region of the sidewall rubber is formed by a coating rubber layer having a thickness of 0.2 to 1.0 mm. According to this configuration, however, it was found that endurance can not sufficiently be secured in some cases. That is, in the case of a pneumatic in which a tire cross section height is less than 110 mm and an aspect ratio (tire cross section height/tire cross section width) is small, since a large distortion is applied to a region extending from a shoulder portion to a tire maximum width position when a load rolls during running, it was found that a crack along the ribbon interface is generated on the coating rubber layer in this region.

In Japanese Patent Application Laid-open No. 2002-79590 and Japanese Patent Application Laid-open No. 2005-225278, it is proposed that a superposed width of the rubber ribbons forming the outer peripheral surface of the sidewall rubber is limited, thereby reducing the ribbon interface formed in the sidewall outer peripheral wall. In the case of a pneumatic tire whose tire cross section height is less than 110 mm, it is very important to reduce the ribbon interface formed in a region extending from a shoulder portion to a tire maximum width position to a minimum for preventing a crack. In the above configuration, however, since a small ribbon interface is formed in the region, a crack can not sufficiently be suppressed.

### SUMMARY OF THE INVENTION

The present invention has been accomplished in view of the above circumferences, and it is an object of the invention to provide a pneumatic tire in which a tire cross section height is less than 110 mm, and a crack which is generated due to a ribbon interface of a sidewall outer peripheral wall can be suppressed.

The object can be achieved by the present invention having the following structure. That is, the present invention provides a pneumatic tire comprising a pair of bead portions, sidewall portions respectively extending from the bead portions radially outward of the tire, and a tread portion connected to radially outer ends of the sidewall portions through shoulder portions, wherein a tire cross section height is less than 110 mm, a sidewall rubber disposed in the sidewall portion is formed of a laminated body of a narrow rubber ribbon wound along a circumferential direction of the tire, an outer peripheral wall of a region extending from the shoulder portion of the sidewall rubber to a tire maximum width position is formed of a wide rubber ribbon which is wider than the narrow rubber ribbon and which has a thickness of 1.2 to 3.0 mm.

According to a pneumatic tire of the present invention, an outer peripheral wall of a region where a large distortion is applied during running of a sidewall rubber made of laminated body of narrow rubber ribbon is formed with a wide rubber ribbon which is wider than a narrow rubber ribbon constituting the sidewall rubber, and the thickness of the wide rubber ribbon is 1.2 to 3.0 mm. With this, it is possible to reduce the ribbon interface in the region of the sidewall outer peripheral wall to a minimum, the endurance is secured, and a crack generated due to the ribbon interface can effectively be suppressed.

In the invention, it is preferable that the narrow rubber ribbon has a width of 10 to 25 mm. With this, it is possible to precisely form the sidewall rubber and to enhance the endurance without deteriorating the productivity. That is, if the width of the narrow rubber ribbon exceeds 25 mm, there is a tendency that a step formed along the ribbon interface becomes large and a crack is easily generated in some cases. If the width is less than 10 mm, since the number of windings of the narrow rubber ribbon is increased, time required for forming the sidewall rubber is increased and there is a tendency that the productivity is deteriorated.

In the present invention, it is preferable that the wide rubber ribbon has such a shape that its end is thinner than the central portion and the end thickness is 0.3 to 0.8 mm. If the end thickness is 0.8 mm or less, the step at the wide rubber ribbon end becomes small, and rubber flow failure at the step at the time of vulcanization can be prevented. As a result, it is possible to ensure the endurance of the sidewall outer peripheral wall, and to effectively suppress the generation of a crack.

### BRIEF DESCRIPTION OF THE DRAWINGS

FIG. 1 is a semi-sectional view of a meridian showing one example of a pneumatic tire of the present invention; and

FIG. 2 is a semi-sectional view of a meridian showing one example of a pneumatic tire produced by a conventional method.

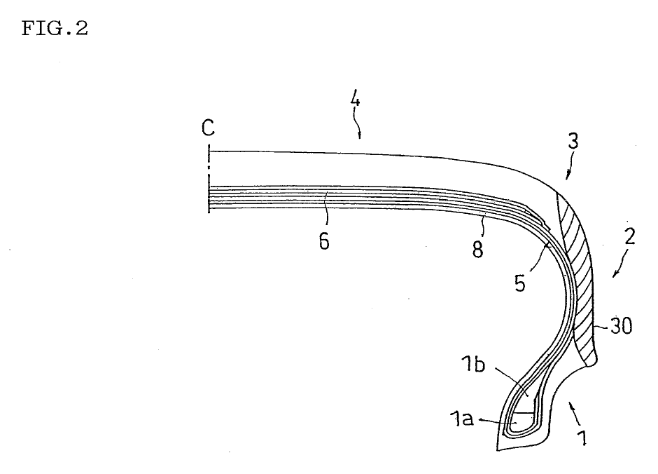

### DESCRIPTION OF THE PREFERRED EMBODIMENTS

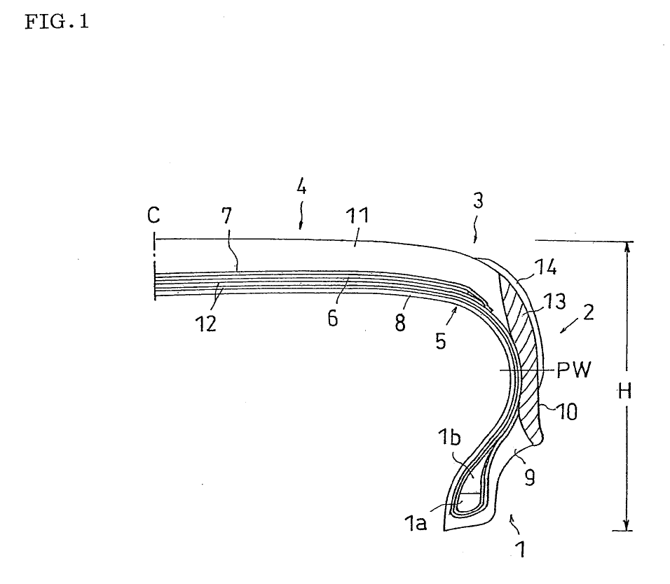

An embodiment of the present invention will be explained with reference to the drawings. FIG. 1 is a semi-sectional view of a meridian showing one example of a pneumatic tire of the present invention. The pneumatic tire comprises a pair of bead portions 1, sidewall portions 2 respectively extending radially outward of the tire from the bead portion 1, and a tread portion 4 connected to radially outer ends of the sidewall portions 2 through shoulder portions 3. In the bead portion 1, an annular bead 1a formed by a convergence body of steel wire, and a bead filler 1b disposed radially outward of the tire of the bead 1a.

The carcass layer 5 includes at least one carcass ply comprising a ply cord extending at an angle of about 90° with respect to a tire equator C. In this embodiment, two carcass plies 12 extend between the pair of beads 1a. The cord constituting the carcass ply 12 is not limited to the polyester cord, and organic fiber such as rayon, nylon and aramid, and steel can also be used suitably.

A belt layer 6 for reinforcing the tire by hoop effect is disposed outside of a tread portion of the carcass layer 4. The belt layer 6 is formed in such a manner that two belt plies in which steel cords are inclined by about 20° with respect to the tire equator C are laminated such that the inclination angles of the steel cords are opposite from each other. A belt reinforcing layer 7 for reinforcing the hoop effect is disposed outside of the tire of the belt layer 6, and a tread rubber 11 is disposed further outer side of the tire. An inner liner rubber 8 for holding an internal pressure of the tire is disposed inside of the tire of the carcass layer 5.

The sidewall rubber 10 disposed in the sidewall portion 2 is formed of laminated body of a narrow rubber ribbon 13 wound along the tire circumferential direction. The narrow rubber ribbon 13 in the drawings is described schematically, but the actual narrow rubber ribbon 13 is delicate and its cross section shape is complicated. The width of the narrow rubber ribbon 13 is preferably 10 to 25 mm. With this, it is possible to precisely form the sidewall rubber 10 and to enhance the endurance without deteriorating the productivity.

It is preferable that the thickness (maximum thickness) of the narrow rubber ribbon 13 is 1 to 3 mm. If the thickness of the narrow rubber ribbon 13 exceeds 3 mm, the step formed along the ribbon interface becomes large, and there is a tendency that the endurance is deteriorated. If the thickness is less than 1 mm, since the number of windings of the narrow rubber ribbon 13 is increased, time required for forming the sidewall rubber 10 is increase and there is a tendency that the productivity is deteriorated.

It is preferable that the shape of the narrow rubber ribbon 13 is a trapezoidal shape, a parallelogram shape, a triangular shape, a crescentic shape, a saucer elliptic shape and the like, and it has a cross section shape whose end is thinner than its central portion. With this, the wound narrow rubber ribbon 13 can easily be superposed in the widthwise direction and thus, the sidewall rubber 10 can be formed more precisely. In this case, it is preferable that the thickness of the end of the narrow rubber ribbon 13 is 0.3 to 0.8 mm. If the end thickness exceeds 0.8 mm, the above-described effect obtained by the fact that the end is thinner than the central portion becomes small. If the end thickness is less than 0.3 mm, the ribbon end is cut, stable ribbon shape can not be maintained, and there is a tendency that it becomes difficult to form and wind the narrow rubber ribbon 13.

An outer peripheral wall of a region extending from a shoulder portion 3 of the sidewall rubber 10 to a tire maximum width position PW is formed of a wide rubber ribbon 14 which is wider than a narrow rubber ribbon 13 and which has a thickness of 1.2 to 3.0 mm. The wide rubber ribbon 14 is annularly connected such as to coat the ribbon interface formed in the region, a radially outer end of the wide rubber ribbon 14 is disposed near the shoulder portion 3, and a radially inner end of the wide rubber ribbon 14 is disposed radially inner side than the tire maximum width position PW. The tire cross section height H of the pneumatic tire is less than 110 mm. A large distortion is applied to the region extending from the shoulder portion 3 to the tire maximum width position PW during running, but no ribbon interface is exposed in the region due to the wide rubber ribbon 14, and a crack is effectively restrained from being generated. The tire maximum width position PW means a maximum width position of a tire profile in the tire meridian cross section, and a rim protector 9 expanding outward of the tire is not taken into consideration.

The thickness of the wide rubber ribbon 14 is 1.2 to 3.0 mm as described above. With this, it is possible to secure the endurance while reducing the ribbon interface in the region of the sidewall outer peripheral wall to a minimum. That is, if the thickness of the wide rubber ribbon 14 is less than 1.2 mm, sufficient endurance can not be secured, and a crack is not prevented from being generated in some cases. If the thickness exceeds 3.0 mm, the endurance is enhanced to almost the same degree as that when the thickness is 3.0 mm, but there is a tendency that the uniformity of the tire is deteriorated.

The width of the wide rubber ribbon 14 is 25 to 70 mm, for example, and a width capable of forming a sidewall outer peripheral wall of a region extending from the shoulder portion 3 to the tire maximum width position PW can be employed. In the case of a pneumatic tire having the tire cross section height of less than 110 mm, if the width of the wide rubber ribbon 14 is 70 mm, this width is sufficient to form the sidewall outer peripheral wall of the region extending from the shoulder portion 3 to the tire maximum width position PW.

It is preferable that the wide rubber ribbon 14 has such a cross section shape that its end is thinner than its central portion such as a trapezoidal shape, a parallelogram shape, a triangular shape, a crescentic shape, a saucer elliptic shape and the like, and the end thickness is 0.3 to 0.8 mm. If the end thickness is 0.8 mm or less, the step of the wide rubber ribbon end becomes small, and rubber flow failure at the step can be prevented at the time of vulcanization. As a result, it is possible to secure the endurance of the sidewall outer peripheral wall more, and it is possible to effectively suppress the generation of a crack. If the thickness is less than 0.3 mm, the ribbon end is cut, and a stable ribbon shape can not be maintained and thus, there is a tendency that it becomes difficult to form and wind the wide rubber ribbon 14.

The pneumatic tire of the present invention can be formed in the same manner as the conventional method except that the outer peripheral wall in the region extending from the shoulder portion 3 of the sidewall rubber 10 to the tire maximum width position PW is formed of the wide rubber ribbon 14. One example of the producing method of the pneumatic tire will be explained briefly.

First, an inner liner rubber 8 and a carcass ply 12 having predetermined widths are sequentially stuck and laminated on an outer periphery of a forming drum. Then, the annular bead 1a and the bead filler 1b are fitted over the both sides of the carcass ply 12, the end of the carcass ply 12 in the widthwise direction is wound back outward, and the sidewall rubber 10 and other rubber member are sequentially disposed to form a first case. The sidewall rubber 10 is formed of a laminated body of the narrow rubber ribbon 13 wound along the circumferential direction.

Next, a cylindrical second case comprising a belt member constituting a belt layer 6 and a belt reinforcing layer 7 and a tread rubber 11 is disposed on an outer periphery side of a central portion of a first case, the central portion of the first case is allowed to swell and deform radially outward, and the central portion is crimped by the inner peripheral surface of the second case. This step can smoothly be carried out using a rubber bag called bladder or a conventionally known drum diameter spreading mechanism while displacing a pair of beads la fixed by a conventionally known bead lock mechanism such that the beads approach and contact with each other.

Next, the wide rubber ribbon 14 is annularly stuck around an outer periphery of a region extending from the shoulder portion 3 of the sidewall rubber 10 to the tire maximum width position PW over one turn such as to cover the ribbon interface of the narrow rubber ribbon 13 formed in that region. At that time, a radially outer end of the wide rubber ribbon 14 is disposed in the vicinity of the shoulder portion 3, and a radially inner end of the wide rubber ribbon 14 reaches the tire maximum width position PW, preferably radially inward of a maximum width position PW.

It is preferable that a terminal end of a joint portion of the wide rubber ribbon 14 is thinner than other portion. With this, the step of the joint portion can be reduced and the uniformity of the tire can effectively be enhanced. Such a wide rubber ribbon is formed by reducing the discharging amount of the winding-completion terminal end when the rubber is extruded using, for example, an extruder having a gear pump.

The obtained raw tire is set in a mold having a predetermined shaped cavity and is subjected to the vulcanization processing and becomes a product tire.

### EXAMPLES

An example tire which concretely shows the structure and effect of the present invention will be explained.

(1) Endurance

An endurance test was carried out in accordance with a method defined in JISD4230, and a traveled distance until a crack was found in a sidewall portion was measured. A test tire was mounted on a rim of size 17×7.5 JJ, and an internal pressure was set to 220 kPa. A result of an embodiment 2 was defined as 100, and indices were evaluated. As the numeric value is greater, the traveled distance is longer, i.e., the endurance is more excellent.

(2) Productivity

Time required for forming the raw tire was measured and the productivity was evaluated. The embodiment 2 was defined as 100, and indices were evaluated. As the numeric value is greater, the forming time is shorter, i.e., the endurance is more excellent.

(3) Uniformity

Based on a test method defined in JISD4233, RFV was measured, and uniformity of a tire was evaluated. The comparative example 2 is set to 100 and a result is evaluated with indices, the more the numeric value is, the more excellent the uniformity is.

For the evaluation of each item, in the tire configuration shown in FIG. 1, a test tire having size of 205/40ZR17 84W (tire cross section height of 82 mm) was used. A table 1 shows a result when a sidewall rubber was formed of a laminated body which was obtained by winding a narrow rubber ribbon having a width of 20 mm, a thickness of 1.5 mm (end thickness of 0.4 mm) and having a triangular cross section, a sidewall outer peripheral wall of a region extending from a shoulder portion to a tire maximum width position was formed of a wide rubber ribbon having a width of 45 mm and having a trapezoidal shape, and the thickness of the wide rubber ribbon was varied. In the conventional example, however, the wide rubber ribbon was not disposed, and the ribbon interface of the narrow rubber ribbon was exposed.

TABLE 1

| | Narrow rubber ribbon | | | | | | | |
|---|---|---|---|---|---|---|---|---|
| | Width | | | Wide rubber ribbon | | | | |
| | of | Maximum | End | Maximum | End | | | |
| | ribbon | thickness | thickness | thickness | thickness | Result of test | | |
| | (mm) | (mm) | (mm) | (mm) | (mm) | Endurance | Productivity | Uniformity |
| Conventional | 20 | 1.5 | 0.4 | — | — | 30 | 120 | 110 |
| example | | | | | | | | |
| Comparative | 20 | 1.5 | 0.4 | 0.8 | 0.8 | 70 | 100 | 104 |
| example 1 | | | | | | | | |
| Comparative | 20 | 1.5 | 0.4 | 1.0 | 1.0 | 72 | 100 | 102 |
| example 2 | | | | | | | | |
| Example 1 | 20 | 1.5 | 0.4 | 1.2 | 1.2 | 75 | 100 | 100 |
| Example 2 | 20 | 1.5 | 0.4 | 1.2 | 0.8 | 100 | 100 | 100 |
| Example 3 | 20 | 1.5 | 0.4 | 3.0 | 0.8 | 105 | 105 | 90 |
| Comparative | 20 | 1.5 | 0.4 | 4.0 | 0.8 | 105 | 105 | 75 |
| example 3 | | | | | | | | |

In the conventional example, a crack was found in the sidewall outer peripheral wall when the traveled distance was relatively short. This crack was generated in the circumferential direction along the ribbon interface in a region extending from the shoulder portion to the tire maximum width position. In the comparative examples 1 and 2, endurance was not sufficiently secured as compared with the embodiments 1 to 3. In the comparative example 3, the uniformity was deteriorated due to the relatively thick wide rubber ribbon. In the embodiments 1 to 3, a crack is prevented from being generated without deteriorating the productivity and uniformity. Especially in the embodiments 2 and 3, it can be found that if the end thickness of the wide rubber ribbon is set to 0.8 mm, the endurance is effectively secured.

A table 2 shows a result when each size of the narrow rubber ribbon is varied. Concerning the result of each item, a result of the embodiment 6 is defined as 100 instead of the embodiment 2 and indices are evaluated.

TABLE 2

| | Narrow rubber ribbon | | | | | | | |
|---|---|---|---|---|---|---|---|---|
| | Width | | | Wide rubber ribbon | | | | |
| | of | Maximum | End | Maximum | End | | | |
| | ribbon | thickness | thickness | thickness | thickness | Result of test | | |
| | (mm) | (mm) | (mm) | (mm) | (mm) | Endurance | Productivity | Uniformity |
| Example 4 | 25 | 1.5 | 0.8 | 1.2 | 0.8 | 85 | 105 | 100 |
| Example 5 | 25 | 1.5 | 0.8 | 3.0 | 0.8 | 105 | 105 | 90 |
| Comparative | 25 | 1.5 | 0.8 | 4.0 | 0.8 | 105 | 105 | 75 |
| Example 4 | | | | | | | | |
| Example 6 | 20 | 1.5 | 0.8 | 1.2 | 0.8 | 100 | 100 | 100 |
| Example 7 | 10 | 1.0 | 0.8 | 1.2 | 0.8 | 110 | 90 | 105 |
| Example 8 | 10 | 0.6 | 0.6 | 1.2 | 0.8 | 120 | 80 | 105 |
| Example 9 | 10 | 0.6 | 0.6 | 3.0 | 0.8 | 130 | 80 | 95 |
| Example 10 | 6 | 0.6 | 0.6 | 1.2 | 0.8 | 130 | 50 | 105 |

In the embodiment 4, the width of the narrow rubber ribbon is set to 25 mm. With this, the productivity is relatively excellent, but since the step formed along the ribbon interface is relatively large, the endurance is slightly deteriorated, and it can be found that the preferable width of the narrow rubber ribbon is 25 mm or less. In the embodiment 5, the thickness of the wide rubber ribbon is increased and thus, the endurance is sufficiently secured, but if the thickness is excessively thick, the uniformity is deteriorated as the comparative example 4. In the embodiment 10, the productivity is deteriorated because the number of windings of the narrow rubber ribbon is increased, and it can be found that the preferable width of the narrow rubber ribbon is 10 mm or more.

1. A pneumatic tire comprising a pair of bead portions, sidewall portions respectively extending from the bead portions radially outward of the tire, and a tread portion connected to radially outer ends of the sidewall portions through shoulder portions, wherein
a tire cross section height is less than 110 mm, a sidewall rubber disposed in the sidewall portion is formed of a laminated body of a narrow rubber ribbon wound along a circumferential direction of the tire,
an outer peripheral wall of a region extending from the shoulder portion of the sidewall rubber to a tire maximum width position is formed of a wide rubber ribbon which is wider than the narrow rubber ribbon and which has a thickness of 1.2 to 3.0 mm.

2. The pneumatic tire according to claim 1, wherein the narrow rubber ribbon has a width of 10 to 25 mm.

3. The pneumatic tire according to claim 1, wherein an end of the wide rubber ribbon is thinner than a central portion of the wide rubber ribbon, a thickness of the end is 0.3 to 0.8 mm.

4. A pneumatic tire having a tire cross section height of less than 110 mm, comprising:
a pair of bead portions;
sidewall portions respectively extending from the bead portions radially outward of the tire, wherein a sidewall rubber is disposed in each sidewall portion, said sidewall rubber being formed of a laminated body of a narrow rubber ribbon wound along a circumferential direction of the tire, and wherein a tire maximum width position is located in each sidewall portion;
shoulder portions respectively extending from the sidewall portions radially outward of the tire; and
a tread portion connected to radially outer ends of the shoulder portions,
wherein an outer wall of a region extending from each shoulder portion in the vicinity of the sidewall rubber to the tire maximum width position is formed of a wide rubber ribbon which has a width greater than that of the narrow rubber ribbon and which has a thickness of 1.2 to 3.0 mm.

5. The pneumatic tire according to claim 4, wherein the narrow rubber ribbon has a width of 10 to 25 mm.

6. The pneumatic tire according to claim 4, wherein ends of the wide rubber ribbon with respect to a width direction of the wide rubber ribbon have a thickness smaller than that of a central portion of the wide rubber ribbon.

7. The pneumatic tire according to claim 6, wherein the thickness of the ends is 0.3 to 0.8 mm.

8. The pneumatic tire according to claim 4, wherein the wide rubber ribbon has a width of 25 to 70 mm.

9. The pneumatic tire according to claim 4, wherein the wide rubber ribbon is wound once along a circumferential direction of the tire.

10. The pneumatic tire according to claim 4, wherein the region extending from each shoulder portion in the vicinity of the sidewall rubber to the tire maximum width position has a radially outer end and a radially inner end, said radially outer end extending radially outward beyond a radially outer end of the sidewall rubber, said radially inner end extending radially inward beyond the tire maximum width position.

11. The pneumatic tire according to claim 4, wherein the narrow rubber ribbon has a thickness of 1 to 3 mm.

12. The pneumatic tire according to claim 4, wherein ends of the narrow rubber ribbon with respect to a width direction of the narrow rubber ribbon have a thickness smaller than that of a central portion of the narrow rubber.

13. The pneumatic tire according to claim 12, wherein the thickness of the ends is 0.3 to 0.8 mm.
